(19) United States
(12) Patent Application Publication
(10) Pub. No.: US 2019/0381450 A1
(43) Pub. Date: Dec. 19, 2019

(54) SYSTEMS, PROCESSES AND METHODS FOR CONCENTRATING ACID GAS AND PRODUCING HYDROCARBON LIQUID WITH A MEMBRANE SEPARATION SYSTEM

(71) Applicants: L'Air Liquide, Societe Anonyme pour l'Etude et l'Exploitation des Procedes Georges Claude, Paris (FR); AIR LIQUIDE ADVANCED TECHNOLOGIES US LLC, Houston, TX (US)

(72) Inventors: Fan Z. WORLEY, Hockessin, DE (US); Edgar S. Sanders, JR., Newark, DE (US)

(73) Assignees: L'Air Liquide, Societe Anonyme pour l'Etude et l'Exploitation des Procedes Georges Claude, Paris (FR); AIR LIQUIDE ADVANCED TECHNOLOGIES U.S. LLC, Houston, TX (US)

(21) Appl. No.: 16/011,824

(22) Filed: Jun. 19, 2018

(51) Int. Cl. B01D 53/22; B01D 53/00; F25J 1/00; C10G 31/09; C10L 3/10; E21B 43/34

(52) U.S. Cl. CPC B01D 53/229; B01D 53/002; F25J 1/0022; F25J 1/0042; C10G 31/09; B01D 2257/304; C10L 3/104; E21B 43/34; B01D 2256/245; B01D 2257/504; C10L 3/103

(57) ABSTRACT

Disclosed is a method for producing a liquid hydrocarbon comprising dividing a feed gas into a first feed gas stream and a second feed gas stream, separating the first feed gas stream through a membrane separation unit into an acid gas-enriched permeate gas stream and a biphasic non-permeate stream of acid gas-reduced hydrocarbon-enriched gas and liquid, separating the biphasic non-permeate stream of acid gas-reduced hydrocarbon-enriched gas and liquid into a first liquid hydrocarbon stream and an acid gas-depleted methane-rich gas stream, expanding the second feed gas stream to produce a hydrocarbon gas stream containing the acid gas in equilibrium with a second liquid hydrocarbon stream with an expander, commingling the first liquid hydrocarbon stream with the second liquid hydrocarbon stream to produce the liquid hydrocarbons product, commingling the acid gas-enriched permeate gas stream with the hydrocarbon gas stream containing the acid gas and collecting the acid gas-depleted methane-rich gas stream.

### FIELD OF THE INVENTION

The present invention relates to systems, processes and methods for concentrating acid gas and producing hydrocarbon liquids from a feed gas with a membrane separation system, in particular, for concentrating acidic gases, such as, CO₂ and/or H₂S gas and producing a natural gas liquid stream and a reduced acid gas, methane-rich gas stream by means of parallel operation of a membrane separation unit and an isentropic expander.

### BACKGROUND

Natural gas is a naturally occurring hydrocarbon gas mixture consisting primarily of methane but includes varying amounts of other higher alkanes. Depending on the source, natural gas may contain carbon dioxide, nitrogen, hydrogen sulfide, and/or helium. Associated natural gas or associated gas is natural gas coproduced in conjunction with oil production. Associated natural gas typically contains significant amounts of other hydrocarbons such as ethane, propane, butane, pentane etc. collectively known as natural gas liquids. Besides hydrocarbons, the associated gas also may contain carbon dioxide, nitrogen and hydrogen sulfide, which must be removed prior to utilizing the natural gas or natural gas liquids as fuel or chemical feedstock.

In recent years, enhanced oil recovery (EOR) processes have gained in importance. In such processes, gases such as carbon dioxide or nitrogen are injected into the oil formation at strategic locations in order to drive normally unrecoverable oil to the production well. The injected gas becomes part of the associated gas leaving the well and must be separated as described above. Generally, a separation process must take account of the fact that the life of an oil well spans many years, and over that time the production rates of oil and gas vary widely. In the initial years of production, little or no injected fluid is needed to maintain an adequate production level. However, as the well ages it becomes increasingly difficult to recover the petroleum. This is due in part to a decrease in formation pressure caused by prior years' production, but more importantly, a large portion of the crude petroleum is often “bound” to the surrounding formation and may not be recovered absent some extraordinary means, hence, the need for injection of carbon dioxide or nitrogen. Generally, CO₂ is preferred in shallower carbonate oil-bearing formations due to the high CO₂ solubility in the oil and viscosity reduction, while N₂ is used for deep wells primarily for pressure maintenance.

The composition of the associated gas changes over time as more and more gas injectant is injected to maintain a given production rate. Thus, for example, the associated gas may have a carbon dioxide content of anywhere from 0 to 95 mole percent depending on the age of the well. In enhanced recovery processes, the separation of injectant in the associated gas is important from the standpoint of obtaining usable natural gas and natural gas liquids, and even more importantly, for recycling the injection fluid in pure form. Injection fluid such as carbon dioxide has a high initial cost and, in the quantities needed, is expensive to transport and store. Separation and purification is therefore necessary from an economic standpoint. Apparatus for doing this should be capable of handling the entire range of time dependent CO₂ compositions, i.e., CO₂ levels of from essentially zero at the onset of CO₂ injection to 90+ mole percent CO₂/H₂S after years of CO₂ injection. Hydrocarbon liquids contained in the associated gas are often more valuable than the recovered CO₂ and natural gas. The optimal separation system should readily adapt to the increasing feed flow and feed composition as a function of time and produce a saleable natural gas liquid stream, a sweetened residual natural gas as well as a reinjectable enhanced oil recovery stream. Attempts have been made.

At high levels of CO₂ (65%-95%), low temperature distillation is one method of separation. Distillation systems are capable of producing high purity of CO₂ for reinjection but struggle to meet pipeline specifications for natural gas (<2% CO₂). While the Ryan Holmes process was developed by Koch Process Systems to successfully address this technical issue, Ryan Holmes technology (U.S. Pat. Nos. 4,462,814 and 4,318,723) has met with limited commercial success due to process economics.

Amines are most widely used technology for CO₂ and H₂S removal from natural gas. Amine technology (U.S. Pat. Nos. 5,618,506 and 1,783,901) is most applicable for lower levels of CO₂ (<20% CO₂/H₂S). High CO₂ level and heavier hydrocarbons cause the formation of heat stable salts and foaming.

Attempts have also been made at employing the Joule-Thomson effect through a Joule-Thomson valve to membrane separation systems. Exemplary examples of employing the Joule-Thomson valve to the membrane separation systems include US20160326446, DE19856068, U.S. Pat. No. 7,329,306 and WO9405960.

Membrane systems are capable of bulk cut applications and may be used to treat streams as high as 90% CO₂. A design of a conventional membrane-only separation system for separating acid gas, such as CO₂ or H₂S, and hydrocarbons is shown in FIG. 1, which includes a membrane separation unit 105 and a phase separator 106. A feed gas stream 100 is withdrawn from a high-pressure natural gas stream, and passes to a feed side of the membrane separation unit 105. A permeate stream gas 101, enriched in the acid gas, such as CO₂ and/or H₂S, is withdrawn from a permeate side of the membrane separation unit 105. A residue non-permeate stream 102, enriched in hydrocarbons, passes through the phase separator 106 and separates into a hydrocarbon-enriched liquid stream 103 and an acidic gas (e.g., CO₂ and/or H₂S) depleted gas stream 104. Due to acid gas removal from the residue non-permeate stream 102, the hydrocarbons reach the dew point and condense into hydrocarbon liquids. Thus, the residue non-permeate stream 102 has two phases that is separated by the phase separator 106 forming the hydrocarbon-enriched liquid stream 103 and the acidic gas-depleted gas stream 104 that is depleted in CO₂ or H₂S relative to the feed gas and predominately CH₄-enriched stream. Membrane separation unit 105 is composed of bundled membrane separation modules. The number of the bundled membrane separation modules may grow over time with the increase in feed flow and CO₂ or H₂S content, which is cost-consuming.

Thus, there is a demand for developing systems and processes that maximize hydrocarbon production with reduced membrane separation modules.

### SUMMARY

There is disclosed a method for producing a liquid hydrocarbon product comprising the steps of dividing a feed gas into a first feed gas stream and a second feed gas stream by a valve, separating the first feed gas stream through a membrane separation unit into an acid gas-enriched permeate gas stream and a biphasic non-permeate stream of acid gas-reduced hydrocarbon-enriched gas and liquid, separating the biphasic non-permeate stream of acid gas-reduced hydrocarbon-enriched gas and liquid into a first liquid hydrocarbon stream and an acid gas-depleted methane-rich gas stream by a phase separator, expanding the second feed gas stream to produce a hydrocarbon gas stream containing the acid gas in equilibrium with a second liquid hydrocarbon stream with an expander, commingling the first liquid hydrocarbon stream with the second liquid hydrocarbon stream to produce the liquid hydrocarbons product, commingling the acid gas-enriched permeate gas stream with the hydrocarbon gas stream containing the acid gas to produce an acid gas reinjectate, and collecting the acid gas-depleted methane-rich gas stream for use as fuel or further processing to meet pipeline natural gas specifications.

The above disclosed method may include one or more of the following aspects:
the step of separating the hydrocarbon gas stream containing the acid gas and the second liquid hydrocarbon stream from the expander by an additional phase separator;
the step of cooling the biphasic non-permeate stream of acid gas-reduced hydrocarbon-enriched gas and liquid by heat exchange with the hydrocarbon gas stream containing the acid gas in a heat exchanger, thereby increasing an output of the biphasic non-permeate stream of acid gas-reduced and hydrocarbon-enriched gas and liquid therefrom;
the acid gas being CO₂;
the acid gas being H₂S;
the membrane separation unit containing the membrane separation modules;
the membrane separation unit comprising the membrane separation module selective for CO₂ and/or H₂S over CH₄;
the membrane separation unit comprising the membrane separation module selective for CO₂/CH₄;
the membrane separation unit comprising the membrane separation module selective for H₂S/CH₄;
a polymer material forming the membrane separation modules having a CO₂ permeance ranging from approximately 15 to 600 GPU and a selectivity of CO₂/CH₄ ranging from approximately 6 to 40;
a polymer material forming the membrane separation module having a CO₂ permeance 600 GPU and a CO₂/CH₄ selectivity of 10;
a polymer material forming the membrane separation module having a CO₂ permeance of 40 GPU and a CO₂ over CH₄ selectivity of 33;
the membrane separation unit comprising multiple membrane separation modules;
the multiple membrane separation modules forming an array of the membrane separation modules;
the array including a plurality rows of membrane separation modules arranged in parallel in which a plurality of membrane separation modules is arranged in series in each row;
the at least two membrane separation modules being installed in parallel in the membrane separation unit;
the membrane separation modules or bundles being hollow fiber bundles;
the membrane separation modules or bundles being spiral wound bundles;
the expander being an isentropic expander;
the isentropic expander being a Joule-Thomson valve;
the isentropic expander being a turboexpander;
the feed gas including approximately 65-95% CO₂, balanced with hydrocarbons, and other gases;
the feed gas including approximately 65-95% CO₂, balanced with hydrocarbons, and H₂S;
the feed gas containing about 90% CO₂, about 4% methane, about 2% ethane and about 3% C₃₊ hydrocarbons;
the feed gas stream being a feed gas stream that is a gas mixture, such as CO₂, H₂S and condensable hydrocarbons;
the feed gas being associated gas;
the feed gas being a gas stream from another membrane unit;
a pressure of the acid gas-enriched permeate gas stream of the membrane separation module ranging from approximately 1 to approximately 20 bar;
a pressure of the acid gas-enriched permeate gas stream of the membrane separation module ranging from approximately 1 to approximately 10 bar;
a pressure of the acid gas-enriched permeate gas stream of the membrane separation module ranging from approximately 1 to approximately 5 bar;
a pressure of the acid gas-enriched permeate gas stream of the membrane separation module being approximately 1 bar;
a pressure of the acid gas-enriched permeate gas stream of the membrane separation module being around ambient pressure; and
the hydrocarbon gas stream containing the acid gas comprising C₁-C₆ hydrocarbons, CO₂, and H₂S;
the acid gas containing hydrocarbon gas stream comprising C₁-C₆ hydrocarbons, CO₂, and H₂S.

There is also disclosed a system for producing hydrocarbons, the system comprising a source of a feed gas, a valve having an inlet and first and second outlets, the valve being configured and adapted to divide the feed gas into a first feed gas stream and a second feed gas stream, a separation stage, comprising at least one membrane and an optional first phase separator, an inlet of the separation stage being in fluid communication with a first outlet of the valve, the separation stage being configured and adapted to separate the first feed gas stream into an acid gas-enriched permeate gas stream, a first liquid hydrocarbon stream and an acid gas-depleted/methane-rich gas stream, an expander, an inlet of the expander being in fluid communication with a second outlet of the valve, the expander being configured and adapted to cool the second feed gas stream through pressure reduction to produce an acid gas-containing hydrocarbon gas stream in equilibrium with a second liquid hydrocarbon stream, wherein the first liquid hydrocarbon stream is commingled with the second liquid hydrocarbon stream to produce a liquid hydrocarbon product; wherein the acid gas-enriched permeate gas stream is commingled the acid gas-containing hydrocarbon gas stream to produce an acid gas stream for reinjection into a reservoir, and wherein the acid gas-depleted methane-rich gas stream is collected for use as fuel or further processing to meet pipeline natural gas specifications.

The disclosed system includes one or more of the following aspects:
the first liquid hydrocarbon stream being commingled with the second liquid hydrocarbon stream to produce the hydrocarbons;
the acid gas-enriched permeate gas stream being commingled the hydrocarbon gas stream containing the acid gas to produce an acid gas stream for reinjection into a reservoir;
the acid gas-depleted methane-rich gas stream being collected for use as fuel or further processing to meet pipeline natural gas specifications;
the separation stage comprising at least one membrane and an optional first phase separator;
the at least one membrane being adapted and configured to separate the first feed gas stream into the acid gas-enriched permeate gas stream and a biphasic non-permeate stream;
the biphasic non-permeate stream being made up of a combination of the acid gas-containing/methane rich gas stream and the first liquid hydrocarbon stream;
the biphasic non-permeate stream having gaseous and liquid phases;
the optional phase separator being present in the separation stage;
the optional phase separator comprising a drain;
a second phase separator, an inlet of which being in fluid communication with an outlet of the expander, the second phase separator being configured and adapted to separate the acid gas-containing hydrocarbon gas stream and the second liquid hydrocarbon stream produced by the expander;
the separation stage comprising a heat exchanger;
the heat exchanger configured and adapted to exchange heat between the acid gas-containing hydrocarbon gas stream and the biphasic non-permeate stream so as to heat the acid gas-containing hydrocarbon gas stream and cool the biphasic non-permeate stream, thereby increasing an amount of the liquid phase of the biphasic non-permeate stream, reducing an amount of the gaseous phase of the biphasic non-permeate stream, and increase a recovery of the liquid hydrocarbon product; and
the valve being a flow control valve.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a block diagram of a conventional membrane separation system;

FIG. 2 is a block diagram of an embodiment of disclosed membrane separation systems;

FIG. 3 is a block diagram of an alternative embodiment of disclosed membrane separation systems; and

FIG. 4 is a block diagram of an exemplary membrane separation unit utilized in the disclosed systems.

### DESCRIPTION OF PREFERRED EMBODIMENTS

Disclosed are systems, processes and methods for concentrating acid gas and producing hydrocarbon liquids from a feed gas with a membrane separation system, in which a membrane separation unit in combination with an isentropic expander is applied to separate components of the feed gas containing acid gas (e.g., CO₂ and/or H₂S) and hydrocarbons to produce an acid gas-rich stream, a liquid hydrocarbon stream and an acid gas-reduced methane-rich gas stream.

In the drawing, the processes of the disclosed systems are illustrated by means of simplified flow diagrams in which such details as pumps, instrumentation, heat-exchangers and heat-recovery circuits, compressors, and similar hardware have been deleted as being non-essential to an understanding of the techniques involved. The use of such miscellaneous equipment is well within the purview of one skilled in the art.

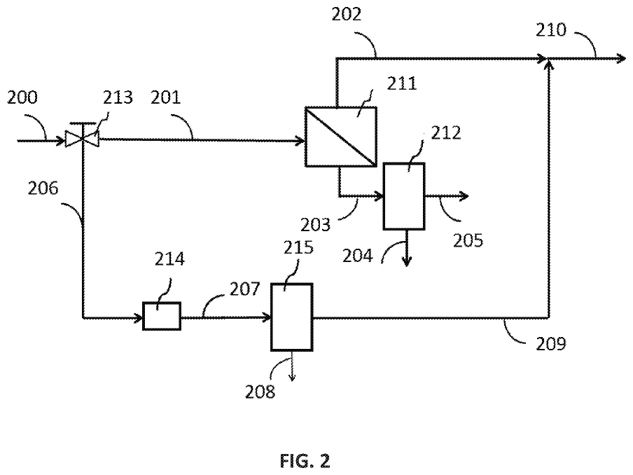

Referring to FIG. 2, there is shown an embodiment of the disclosed systems including a valve 213, a membrane separation unit 211 and an expander 214. The valve 213 divides a feed gas 200 into a first feed gas stream 201 and a second feed gas stream 206. The membrane separation unit 211 comprises a non-permeate side and a permeate side and is capable of separating a first feed gas stream 201 into a permeate stream 202 coming from the permeate side and a non-permeate stream 203 coming from the non-permeate side. The expander 214 is capable of cooling a second feed gas stream 206 to produce a cooled stream 207 including an acid gas-enriched gas stream 209 in equilibrium with a hydrocarbon-enriched liquid stream 208. The disclosed system shown in FIG. 2 is capable of maximizing recovery of acidic gas and liquid hydrocarbon products from the feed gas stream 200.

The feed gas 200 may be an associated natural gas stream or associated gas stream resulting from oil production enhanced by CO₂ flooding or CO₂ EOR. The associated gas is natural gas coproduced in conjunction with oil production, and typically contains significant amounts of other hydrocarbons such as ethane, propane, butane, pentane etc. collectively known as natural gas liquids. Besides hydrocarbons, the associated gas also may contain carbon dioxide, nitrogen and hydrogen sulfide, which may be removed prior to utilizing the natural gas or natural gas liquids as fuel or chemical feedstock. In CO₂ EOR, high pressure CO₂ is injected into a reservoir/well to increase oil production. Over a period of time, CO₂ levels build and eventually break through into the produced oil and associated gas. It is desirable to recover CO₂ from the associated natural gas for reinjection into the well and recover hydrocarbon liquids as products for chemical manufacture. For the feed gas stream 200, hydrocarbon liquids and CO₂ levels are high and more desired than residual natural gas. The feed gas 200 may contain approximately 65-95% CO₂, balanced with hydrocarbons, and other gases. For example, the feed gas contains approximately 65-95% CO₂, balanced with hydrocarbons, and H₂S. Alternatively, the feed gas 200 may contain about 90% CO₂, about 4% methane, about 2% ethane and about 3% C₃₊ hydrocarbons. In addition, the feed gas stream 200 may be a feed gas stream that is a gas mixture, such as CO₂, H₂S and condensable hydrocarbons. Pre-treatment steps, such as compression to provide high pressure, cooling/heating to change temperature, filter to vary compositions, etc., may be necessary to obtain the feed gas stream 200. Alternatively, the feed gas stream 200 may be a permeate stream from a multistage membrane system or a membrane based pretreatment stream. For either of these cases, the feed gas stream 200 contains high CO₂ concentration (e.g., >approximately 65%) and substantial quantities of condensable hydrocarbons and H₂S gas. The following description is mainly focused on separation of CO₂ form hydrocarbons. The separation of H₂S will be the same as that of CO₂.

The membrane separation unit 211 may be composed of membrane separation modules or bundles selective for CO₂/CH₄, in which a polymer material forming the membrane separation modules may have a CO₂ permeance from 15 to 600 GPU and a selectivity (a) of CO₂/CH₄ between 6 and 40. Preferably, the polymer material forming the membrane separation modules may have a CO₂ permeance of 600 GPU and a CO₂/CH₄ selectivity of 10, or a CO₂ permeance of 40 GPU and a CO₂ over CH₄ selectivity of 33, see the Examples that follow. The membrane separation modules or bundles used for the membrane separation unit 211 may be, but are not limited to, hollow fiber bundles, or spiral wound bundles. The membrane separation unit 211 may be composed of membrane separation modules or bundles selective for H₂S/CH₄ for separation of H₂S from hydrocarbons. The membrane separation unit 211 may be composed of membrane separation modules or bundles selective for CO₂ and/or H₂S over CH₄ for separation of CO₂ and/or H₂S from hydrocarbons.

The expander 214 may be, but is not limited to, an isentropic expander such as a Joule-Thomson valve or equivalent expander, such as, a turboexpander, cooling the second feed gas stream 206.

Besides dividing the feed gas stream 200 into the first feed gas stream 201 and the second feed gas stream 206, the valve 213 is also adjustable to control a flow between the membrane separation unit 211 and the expander 214 to adapt to changes in feed compositions of the feed gas 200 and optimally utilize membrane-based and Joule-Thomson-based separations to meet product specifications. Alternately, the valve 213 may adjust flow rates of the first feed gas stream 201 that goes to the membrane separation unit 211 and the second feed gas stream 206 and that goes to the expander 214. The valve 213 may be, but is not limited to, any commercially available flow control valves suitable for adjusting the flow between the membrane separation unit 211 and the expander 214.

The first feed gas stream 201 passes through the membrane separation unit 211, which separates the first feed gas stream 201 into the permeate stream 202 and the non-permeate stream 203. The permeate stream 202 is predominately CO₂-enriched stream. A pressure of the permeate stream 202 may range from approximately 1 to approximately 20 bar. Preferably, the pressure of the permeate stream 202 may range from approximately 1 to approximately 10 bar. More preferably, the pressure of the permeate stream 202 may range from approximately 1 to approximately 5 bar. Even more preferably, the pressure of the permeate stream 202 may be around ambient pressure, or approximately 1 bar. CO₂ removal from the non-permeate stream 203 causes the hydrocarbons in the non-permeate 203 to reach the dew point and condense into hydrocarbon liquid in equilibrium with hydrocarbon gas. The non-permeate stream 203 has two phases of gas and liquid and is enriched in hydrocarbon liquids. A first phase separator (commonly called a knock out) 212 is used to separate the non-permeate stream 203 into a first hydrocarbon-enriched liquid stream 204 and a gas stream 205 that is depleted in CO₂ relative to the feed gas stream 200. The first phase separator 212 may be a vessel that separates fluids into gas and liquid. The first phase separator 212 may be placed downstream of the membrane separation unit 211, wherein an inlet of the first phase separator 212 is in fluid communication with a non-permeate outlet of the membrane separation unit 211. Alternatively, the first phase separator 212 may be a build-in phase separator built in the membrane separation unit 211 (not shown). For example, the first phase separator 212 may be a drain with a valve built in the membrane separation unit 211 that functions as a phase separator. In this case, the first hydrocarbon-enriched liquid stream 204 drains out from the drain and the gas stream 205 comes out from a gas outlet in the membrane separation unit 211. After CO₂ and hydrocarbons are removed from the feed gas stream 200, natural gas may be recovered from the feed gas stream 205. The gas stream 205 is also CH₄-enriched that may be flared, used as fuel gas or further processed to meet pipeline natural gas specifications.

The second feed gas stream 206 of the feed gas stream 200 is allowed to expand through the expander 214. The expansion by the expander 214 through pressure reduction causes the second feed gas stream 206 to cool thereby hydrocarbons being condensed to produce a two phase stream 207. The two phase stream 207 contains a hydrocarbon gas stream 209 containing acid gas in equilibrium with a second hydrocarbon-enriched liquid stream 208. The two phase stream 207 passes into a second phase separator 215 wherein the hydrocarbon gas stream 209 containing acid gas and the second hydrocarbon-enriched liquid stream 208 are separated. The hydrocarbon gas stream 209 containing acid gas passes out of the second phase separator 215 and commingles with the permeate stream 202 produced from the membrane separation unit 211 to form a CO₂-enriched stream 210 as an acid gas reinjectate suitable for reinjection into a well or a reservoir. The second hydrocarbon-enriched liquid stream 208 is withdrawn from the second phase separator 215 and commingled with the first hydrocarbon-enriched liquid stream 204 produced from the membrane separation unit 211 to produce liquid hydrocarbon products for chemical manufacture.

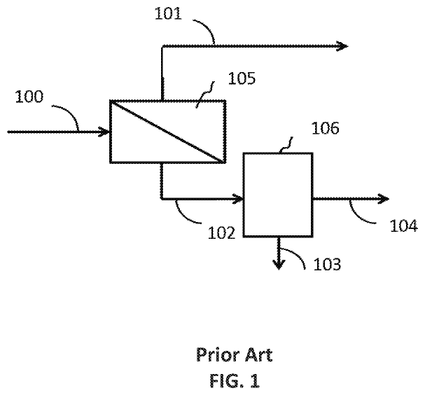

Since the valve 213 controls the flow between the membrane separation unit 211 and the expander 214, the flow goes to the membrane separation unit 211 is reduced comparing to a membrane-only separation unit. This results in a reduction of membrane area thereby resulting in a reduction of the number of membrane separation modules. Thus, parallel use of the membrane separation unit 211 and the expander 214 is cost-effective and improves the lifetime of the membrane separation modules as well. Furthermore, comparing to the membrane-only separation unit as shown in FIG. 1, the disclosed system shown in FIG. 2 may produce more liquid hydrocarbons than the membrane-only separation unit with the same membrane area utilized or utilize less membrane area while producing the same amount of liquid hydrocarbons.

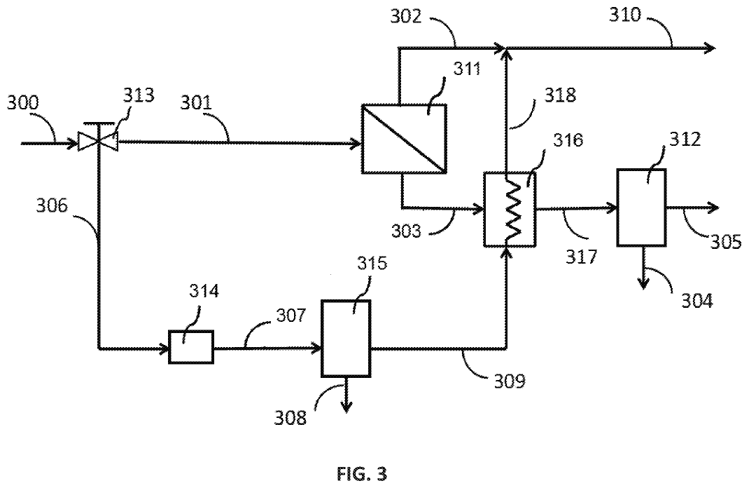

Referring to FIG. 3, an alternative embodiment of the disclosed systems is shown, in which more hydrocarbon liquids may be produced using the same membrane area comparing to the embodiment shown in FIG. 2. The difference between the embodiments of FIG. 2 and FIG. 3 is that FIG. 3 further comprises a heat exchanger 316 downstream of a non-permeate side of the membrane separation unit 311 in between the membrane separation unit 311 and the first phase separator 312. Components of the embodiment of the disclosed system shown in FIG. 3 which are similar to those already described relative to the embodiment of the disclosed system shown in FIG. 2 are indicated with like reference numbers and may not be described again in detail. Similarly, the following description is mainly focused on separation of CO₂ from hydrocarbons. The separation of H₂S will be the same as that of CO₂.

As shown, a feed gas stream 300 is withdrawn from a hydrocarbon rich, high CO₂ natural feed gas stream at high pressure. The feed gas stream 300 is the same as the feed gas stream 200. The feed gas stream 300 includes acid gas and hydrocarbons, such as, CO₂, H₂S, CH₄ and condensable hydrocarbons. The following description is mainly focused on separation of CO₂ from hydrocarbons. The separation of H₂S from hydrocarbons will be Similar. The disclosed separation systems are capable of separating CO₂ from hydrocarbons and also separating H₂S from hydrocarbons.

A valve 313 is used to divide the feed gas stream 300 into a first feed gas stream 301 and a second feed gas stream 306. The first feed gas stream 301 passes through a membrane separation unit 311, which separates the first feed gas stream 301 into the permeate stream 302 and the non-permeate stream 303. A pressure of the permeate stream 302 may range from approximately 1 to approximately 20 bar. Preferably, the pressure of the permeate stream 302 may range from approximately 1 to approximately 10 bar. More preferably, the pressure of the permeate stream 302 may range from approximately 1 to approximately 5 bar. Even more preferably, the pressure of the permeate stream 302 may be around ambient pressure, or approximately 1 bar. CO₂ removal from the non-permeate stream 303 causes the hydrocarbons in the non-permeate 303 to reach the dew point and condense into hydrocarbon liquids in equilibrium with hydrocarbon gas. The non-permeate stream 303 has two phases and is enriched in hydrocarbon liquids. The second feed gas stream 306 is allowed to expand or pressure reduction through an expander 314 to form a cooled, expanded two phase stream 307, where a hydrocarbon gas stream containing CO₂ 309 in equilibrium with a second hydrocarbon liquid stream 308.

The cooled, expanded two phase stream 307 passes into a phase separator 315. The second hydrocarbon liquid stream 308 is withdrawn from the phase separator 315. The hydrocarbon gas stream containing CO₂ 309 passes out of the phase separator 315 and feeds into the heat exchanger 316, where it is brought into heat-exchanging contact to further cool the incoming non-permeate stream 303 to produce a cooled two-phase stream 317. The heat exchanger 316 may be any kind of commercially available heat exchangers used in gas separation industry or those well-known to those skilled in the art of gas separation.

Cooling of the non-permeate stream 303 condenses additional hydrocarbon liquids. Thus, the cooled two-phase stream 317 coming out of the heat exchanger 316 has more hydrocarbon liquids than the non-permeate stream 303. The cooled two-phase stream 317 exits the heat exchanger 316 and passes through a phase separator 312, where the cooled two-phase stream 317 is allowed to separate into a CO₂-depleted methane-enriched gas stream 305 and a first hydrocarbon-enriched liquid stream 304. Since the cooled two-phase stream 317 has more hydrocarbon liquids than the non-permeate stream 203 in the embodiment without the heat exchanger shown in FIG. 2, the first hydrocarbon-enriched liquid stream 304 has more hydrocarbon-enriched liquids than the first hydrocarbon-enriched liquid stream 204 in the embodiment without the heat exchanger shown in FIG. 2, which further increases liquid hydrocarbon recovery. At an gas outlet of the heat exchanger 316, a warmed CO₂-enriched gas stream 318 exits the heat exchanger 316 and commingles with the permeate gas stream 302 to form a CO₂-enriched stream 310 as a CO₂ reinjectate suitable for reinjection into a well or a reservoir. The first hydrocarbon-enriched liquid stream 304 and the second hydrocarbon-enriched liquid stream 308 may be commingled to produce liquid hydrocarbon products for chemical manufacture. The CO₂-depleted methane-enriched gas stream 305 is a methane-enriched stream that can be flared, used as fuel gas or further processed to meet pipeline natural gas specifications.

As described above, the embodiment shown in FIG. 3 produces more hydrocarbon liquids than the embodiment shown in FIG. 2 because the heat exchanger 316 makes more hydrocarbon liquid condensed.

Furthermore, similar to the embodiment shown in FIG. 2, since the valve 313 controls the flow between the membrane separation unit 311 and the expander 314, the flow goes to the membrane separation unit 311 is reduced comparing to a membrane-only separation unit. This results in a reduction of membrane area thereby resulting in a reduction of the number of membrane separation modules. Thus, parallel use of the membrane separation unit 311 and the expander 314 is cost-effective and improves the lifetime of the membrane separation modules as well.

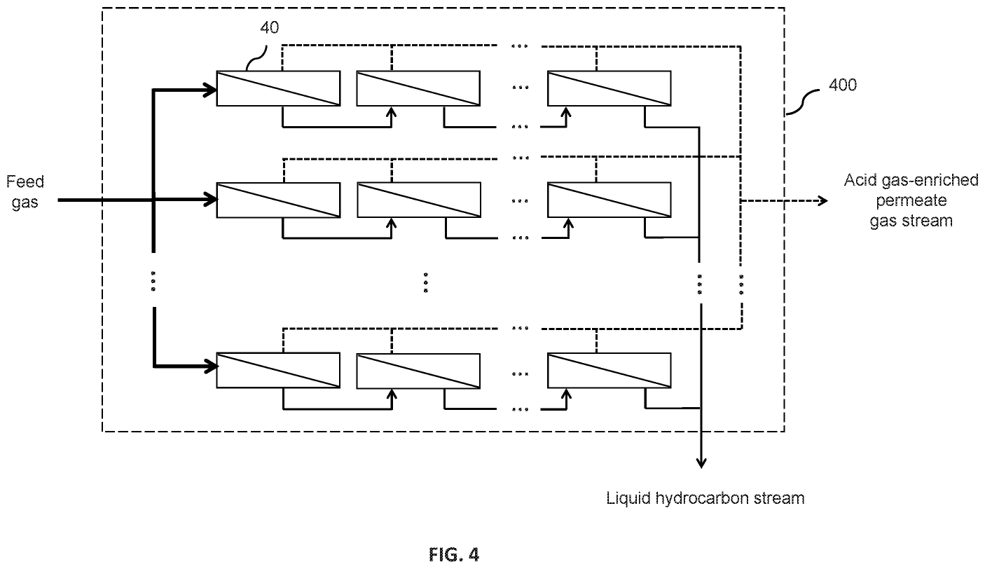

FIG. 4 is a block diagram of an exemplary membrane separation unit utilized in the disclosed systems, for example, in the embodiments shown in FIG. 2 and FIG. 3. The membrane separation unit 400 comprises multiple membrane separation modules 40 (only one is labeled), which forms an array of the membrane separation modules 40. As shown, a plurality rows of membrane separation modules 40 is arranged in parallel in which a plurality of membrane separation modules 40 is arranged in series in each row. Valves (not shown) are installed at an inlet/outlet of each membrane separation module 40 or at the inlet/outlet of each row of membrane separation modules, which control the use of each membrane separation module or each row of membrane separation modules. In one embodiment, the membrane separation unit 400 may have at least two membrane separation modules 40 being installed in parallel. When a feed gas is fed into the membrane separation unit 400, an acid gas-enriched permeate gas stream is produced from the permeate side of the membrane separation unit 400 and a liquid hydrocarbon stream is produced from the non-permeate side of the membrane separation unit 400 (an acid gas-depleted methane-rich gas stream produced from the non-permeate side of the membrane separation unit 400 is not shown). The membrane separation unit 400 may comprise an optional phase separator (not shown) separating the liquid hydrocarbon stream and the acid gas-depleted methane-rich gas stream produced by the membrane separation unit 400. The optional phase separator may be a drain or a port with a valve built in the membrane separation unit 400.

The disclosed systems may be used for separating components of CO₂ and/or H₂S containing, light hydrocarbon rich, sub-quality natural gas feed to produce a CO₂ and/or H₂S-rich stream, a natural gas liquid stream and an acid gas-reduced, methane-rich gas stream by means of parallel operation of a membrane separation unit and a Joule-Thomson expansion valve.

The advantages of the disclosed systems and methods are as follows. The disclosed systems and methods reduce membrane area thereby reduce numbers of membrane separation modules and increase hydrocarbon liquid production. Decreasing the membrane area is cost-effective for separation. The disclosed systems and methods utilize an isentropic expander that increases of natural gas liquid production. The disclosed systems and methods also have good capability of accommodating fluctuations or gradual changes in feed gas compositions. The disclosed systems and methods may control flow rates going to the membrane separation unit and the isentropic expander with minimal adjustment of operating variables and gas processing facilities downstream, as the reservoir changes with time causing changes in feed flows and compositions. Furthermore, in the disclosed systems and methods, in the feed gas, CO₂ concentration may change from time to time and gradually increase as CO₂ flood evolves and CO₂ breakthrough increases. As the membrane ages over time, the membrane performance will drop. However, in the disclosed systems and methods, product specifications, especially product purity and flow rate, may still be met by simply adjusting a flow ratio of the two split feed gas streams without significant changes to the membrane separation unit or gas processing facilities downstream. In addition, the disclosed systems and methods are capable of broadening operability of membrane system for CO₂ recovery.

### EXAMPLES

The following non-limiting examples are provided to further illustrate embodiments of the invention. However, the examples are not intended to be all inclusive and are not intended to limit the scope of the inventions described herein.

### Example 1

A simulation done by using HYSYS was performed to simulate the treatment of a typical raw feed gas stream containing about 90% CO₂, about 4% methane and about 3% C₃+ hydrocarbons. This stream is a typical associated gas produced from a field subjected to CO₂ EOR. It was assumed that the treatment yields a permeate gas flow of at least 17 MMSCFD with at least 97% CO₂. The raw stream to be treated was assumed to have the following mole fractions:

| | |
|---|---|
| Methane | 3.78% |
| Ethane | 2.13% |
| Propane | 1.36% |
| i-Butane | 0.17% |
| n-Butane | 0.48% |
| i-Pentane | 0.18% |
| n-Pentane | 0.20% |
| n-Hexane | 0.33% |
| n-Heptane | 0.16% |
| Carbon Dioxide | 90.29% |
| Nitrogen | 0.89% |
| Water | 0.03% |
| Hydrogen Sulfide | — |

The treatment process was assumed to be carried out according to the conventional membrane separation process design shown in FIG. 1.

The polymer material used for the membrane separation unit in this simulation case was assumed to have a CO₂ permeance of 600 GPU and a CO₂ over CH₄ selectivity of 10. The results of the simulation are shown in Table 1. The stream numbers correspond to FIG. 1.

TABLE 1

| Stream | 100 | 102 | 101 | 104 | 103 |
|---|---|---|---|---|---|
| Temperature [° F.] | 95.0 | 73.6 | 82.2 | 73.6 | 73.6 |
| Pressure [psig] | 465.0 | 437.9 | 150.0 | 437.9 | 437.9 |
| Molar Flow | 31.00 | 14.00 | 17.00 | 13.75 | 0.26 |
| [MMSCFD] | | | | | |
| Component (mol %) | | | | | |
| Methane | 3.78 | 7.20 | 0.96 | 7.31 | 1.27 |
| Ethane | 2.13 | 4.60 | 0.09 | 4.62 | 3.99 |
| Propane | 1.36 | 3.00 | 0.01 | 2.93 | 6.90 |
| i-Butane | 0.17 | 0.38 | 0.00 | 0.35 | 1.78 |
| n-Butane | 0.48 | 1.06 | 0.00 | 0.96 | 6.60 |
| i-Pentane | 0.18 | 0.40 | 0.00 | 0.32 | 4.78 |
| n-Pentane | 0.20 | 0.44 | 0.00 | 0.34 | 6.04 |
| n-Hexane | 0.33 | 0.73 | 0.00 | 0.36 | 20.51 |
| n-Heptane | 0.16 | 0.35 | 0.00 | 0.10 | 14.24 |
| CO₂ | 90.29 | 79.81 | 98.92 | 80.67 | 33.75 |
| Nitrogen | 0.89 | 1.96 | 0.01 | 2.00 | 0.13 |
| H₂O | 0.03 | 0.05 | 0.01 | 0.05 | 0.03 |
| Membrane Area [m²] | 757 | | | | |

| | |
|---|---|
| Hydrocarbon mol % in NGL Stream | 66.10 |
| Total Hydrocarbon Molar Flow [MMSCFD] | 0.169 |

### Example 2

The simulation of Example 1 was repeated, again assuming that the raw gas of the compositions above was to be treated to produce a permeate gas flow of at least 17 MMSCFD with at least 97% CO₂. In Example 2, however, the treatment process was assumed to be carried out according to the disclosed separation system shown in FIG. 2. The valve 213 divided the feed gas 200 into the first feed gas stream 201 and the second feed gas stream 206 at a molar flow rate ratio of 5.25.

It was assumed that the same membrane area and the same polymer material were used as those in the Example 1 for the membrane separation unit in this simulation case. The results of the simulation are shown in Table 2. The stream numbers correspond to FIG. 2. A feed gas stream 210 is-enriched in CO₂. Stream 204 and stream 208 are hydrocarbon-enriched liquid streams, which are recovered hydrocarbon liquids.

The process is able to deliver a permeate feed gas stream of similar quality to that of Example 1. In this case, however, a larger permeate stream is produced, 21.90 MMSCFD, compared with 17.00 MMSCFD in Example 1 (29% more). More specifically, this process produces much more net hydrocarbon liquid, 0.255 MMSCFD (45.3 Mbbl/day), than that (0.169 MMSCFD (30.0 Mbbl/day)) in Example 1, which is 51% more. With the disclosed separation system shown in FIG. 2, the value of the recovered hydrocarbon liquids is greater than the value of the recovered CO₂.

TABLE 2

| Stream | 200 | 203 | 210 | 205 | 204 | 208 |
|---|---|---|---|---|---|---|
| Temperature [° F.] | 95.0 | 70.6 | 62.2 | 70.6 | 70.6 | −1.4 |
| Pressure [psig] | 465.0 | 445.9 | 150.0 | 445.9 | 445.9 | 150.0 |
| Molar Flow [MMSCFD] | 31.00 | 9.05 | 21.90 | 8.72 | 0.33 | 0.05 |
| Component (mol %) | | | | | | |
| Methane | 3.78 | 8.86 | 1.69 | 9.13 | 1.66 | 0.32 |
| Ethane | 2.13 | 5.93 | 0.56 | 5.96 | 5.31 | 1.78 |
| Propane | 1.36 | 3.90 | 0.30 | 3.70 | 9.03 | 4.60 |
| i-Butane | 0.17 | 0.49 | 0.03 | 0.42 | 2.23 | 1.63 |
| n-Butane | 0.48 | 1.38 | 0.09 | 1.13 | 8.04 | 6.81 |
| i-Pentane | 0.27 | 0.52 | 0.03 | 0.34 | 5.26 | 6.07 |
| n-Pentane | 0.20 | 0.58 | 0.03 | 0.35 | 6.48 | 7.96 |
| n-Hexane | 0.29 | 0.95 | 0.02 | 0.31 | 17.88 | 26.30 |
| n-Heptane | 0.03 | 0.46 | 0.00 | 0.07 | 10.71 | 15.48 |
| CO₂ | 90.29 | 74.33 | 97.02 | 75.89 | 33.18 | 29.03 |
| Nitrogen | 0.89 | 2.55 | 0.21 | 2.64 | 0.18 | 0.02 |
| H₂O | 0.03 | 0.06 | 0.02 | 0.06 | 0.03 | 0.01 |
| Membrane Area [m²] | 757 | | | | | |
| Hydrocarbon mol % in NGL Stream | | | | | 66.61 | 70.95 |
| Hydrocarbon Molar Flow [MMSCFD] | | | | | 0.22 | 0.03 |
| Total Hydrocarbon Molar Flow [MMSCFD] | | | | | | 0.255 |

### Example 3

The simulation of Example 2 was repeated, again assuming that the raw gas of the compositions above was to be treated to produce a permeate gas flow of at least 17 MMSCFD with at least 97% CO₂. In Example 3, however, the valve 213 divided the feed gas stream 200 into the first feed gas stream 201 and the second feed gas stream 206 at a molar flow rate ratio of 6.41.

It was assumed that the same polymer material as that in the Example 1 was used for the membrane separation unit 211 in this simulation case. The results of the simulation are shown in Table 3. The stream numbers correspond to FIG. 2. A feed gas stream 210 is-enriched in CO₂. Stream 204 and stream 208 are hydrocarbon-enriched liquid streams, which are recovered hydrocarbon liquids.

The process is able to deliver a permeate feed gas stream of similar quality to that of Example 1. In this case, however, less membrane area is required, i.e., 580 m², compared with 757 m² for Example 1 (23% less).

TABLE 3

| Stream | 200 | 203 | 210 | 205 | 204 | 208 |
|---|---|---|---|---|---|---|
| Temperature [° F.] | 95.0 | 75.3 | 61.6 | 75.3 | 75.3 | −1.4 |
| Pressure [psig] | 465.0 | 430.5 | 150.0 | 430.5 | 430.5 | 150.0 |
| Molar Flow [MMSCFD] | 31.00 | 13.96 | 17.00 | 13.80 | 0.16 | 0.04 |
| Component (mol %) | | | | | | |
| Methane | 3.78 | 6.42 | 1.62 | 6.49 | 1.09 | 0.32 |
| Ethane | 2.13 | 4.01 | 0.59 | 4.02 | 3.39 | 1.78 |
| Propane | 1.36 | 2.61 | 0.33 | 2.57 | 5.90 | 4.60 |
| i-Butane | 0.17 | 0.33 | 0.04 | 0.31 | 1.55 | 1.63 |
| n-Butane | 0.48 | 0.92 | 0.10 | 0.87 | 5.81 | 6.81 |
| i-Pentane | 0.27 | 0.35 | 0.03 | 0.30 | 4.41 | 6.07 |
| n-Pentane | 0.20 | 0.38 | 0.03 | 0.32 | 5.64 | 7.96 |
| n-Hexane | 0.29 | 0.63 | 0.02 | 0.39 | 21.68 | 26.30 |
| n-Heptane | 0.03 | 0.31 | 0.00 | 0.12 | 16.86 | 15.48 |
| CO₂ | 90.29 | 82.29 | 97.01 | 82.85 | 33.54 | 29.03 |
| Nitrogen | 0.89 | 1.70 | 0.22 | 1.72 | 0.10 | 0.02 |
| H₂O | 0.03 | 0.05 | 0.01 | 0.05 | 0.02 | 0.01 |
| Membrane Area [m²] | 580 | | | | | |
| Hydrocarbon mol % in NGL Stream | | | | | 66.33 | 70.95 |
| Hydrocarbon Molar Flow [MMSCFD] | | | | | 0.11 | 0.03 |
| Total Hydrocarbon Molar Flow [MMSCFD] | | | | | | 0.135 |

### Example 4

The simulation of Example 1 was repeated, again assuming that the raw gas of the compositions above was to be treated to produce a permeate gas flow of at least 17 MMSCFD with at least 97% CO₂. In Example 4, however, the treatment process was assumed to be carried out according to the disclosed separation system shown in FIG. 3. The valve 313 divided the feed gas stream 300 into the first feed gas stream 301 and the second feed gas stream 306 at a molar flow rate ratio of 6.41. A heater exchanger 316 was used to increase the production of the recovered hydrocarbon liquids.

It was assumed that the same polymer material as that in the Example 1 was used for the membrane separation unit 311 in this simulation case. The results of the simulation are shown in Table 4. The stream numbers correspond to FIG. 3. A feed gas stream 310 is-enriched in CO₂. Stream 304 and stream 308 are hydrocarbon-enriched liquid streams, which are recovered hydrocarbon liquids.

The process is able to deliver a permeate feed gas stream of similar quality to that of Example 1. In this case, however, less membrane area is required (580 m²) than that (757 m²) in Example 1 (23% less). More specifically, this process produces much more net hydrocarbon liquid (0.313 MMSCFD (55.7 Mbbl/day)) than that (0.169 MMSCFD (30.0 Mbbl/day)) in Example 1, which is 85% more.

TABLE 4

| Stream | 300 | 303 | 317 | 310 | 305 | 304 | 308 |
|---|---|---|---|---|---|---|---|
| Temperature [° F.] | 95 | 75.31 | 61.50 | 80.57 | 61.50 | 61.50 | −1.16 |
| | | 430.4 | 429.9 | 150.0 | 429.9 | 429.9 | |
| Pressure [psig] | 465 | 5 | 5 | 0 | 5 | 5 | 150.50 |
| Molar Flow [MMSCFD] | 31 | 13.96 | 13.96 | 17.00 | 13.69 | 0.27 | 0.04 |
| Component (mol %) | | | | | | | |
| Methane | 3.78 | 6.42 | 6.42 | 1.62 | 6.53 | 1.17 | 0.32 |
| Ethane | 2.13 | 4.01 | 4.01 | 0.59 | 4.02 | 3.75 | 1.78 |
| Propane | 1.36 | 2.61 | 2.61 | 0.33 | 2.53 | 6.64 | 4.60 |
| i-Butane | 0.17 | 0.33 | 0.33 | 0.04 | 0.30 | 1.74 | 1.63 |
| n-Butane | 0.48 | 0.92 | 0.92 | 0.10 | 0.81 | 6.47 | 6.80 |
| i-Pentane | 0.27 | 0.35 | 0.35 | 0.03 | 0.26 | 4.65 | 6.06 |
| n-Pentane | 0.20 | 0.38 | 0.38 | 0.03 | 0.27 | 5.87 | 7.94 |
| n-Hexane | 0.29 | 0.63 | 0.63 | 0.02 | 0.27 | 18.91 | 26.32 |
| n-Heptane | 0.03 | 0.31 | 0.31 | 0.00 | 0.07 | 12.43 | 15.51 |
| CO₂ | 90.29 | 82.29 | 82.29 | 97.01 | 83.17 | 38.22 | 29.03 |
| Nitrogen | 0.89 | 1.70 | 1.70 | 0.22 | 1.74 | 0.11 | 0.02 |
| H₂O | 0.03 | 0.05 | 0.05 | 0.01 | 0.05 | 0.03 | 0.01 |
| H₂S | 0.01 | 0.00 | 0.00 | 0.00 | 0.00 | 0.00 | 0.00 |
| Membrane Area [m²] | 580 | | | | | | |
| Hydrocarbon mol % in NGL Stream | | | | | | 99.86 | 99.97 |
| Hydrocarbon Molar Flow [MMSCFD] | | | | | | 0.27 | 0.04 |
| Total Hydrocarbon Molar Flow [MMSCFD] | | | | | | | 0.313 |

### Example 5

The simulation of Example 1 was repeated, again assuming that raw gas of the composition above was to be treated to produce a permeate gas flow of at least 17 MMSCFD with at least 97% CO₂. The treatment process was assumed to be carried out according to the conventional separation system shown in FIG. 1. The results of the simulation are shown in Table 5. The stream numbers correspond to FIG. 1.

The polymer material used for the membrane separation in this simulation case was assumed to have a CO₂ permeance of 40 GPU and a CO₂ over CH₄ selectivity of 33, which are different from those in Example 1.

TABLE 5

| Stream | 100 | 102 | 101 | 104 | 103 |
|---|---|---|---|---|---|
| Temperature [° F.] | 95.0 | 76.5 | 86.0 | 76.5 | 76.5 |
| Pressure [psig] | 465.0 | 464.8 | 150.0 | 464.8 | 464.8 |
| Molar Flow | 31.00 | 14.00 | 17.00 | 13.75 | 0.25 |
| [MMSCFD] | | | | | |
| Component (mol %) | | | | | |
| Methane | 3.78 | 8.03 | 0.28 | 8.15 | 1.49 |
| Ethane | 2.13 | 4.68 | 0.03 | 4.69 | 4.12 |
| Propane | 1.36 | 3.01 | 0.00 | 2.94 | 6.89 |
| i-Butane | 0.17 | 0.38 | 0.00 | 0.35 | 1.75 |
| n-Butane | 0.48 | 1.06 | 0.00 | 0.96 | 6.45 |
| i-Pentane | 0.18 | 0.40 | 0.00 | 0.32 | 4.64 |
| n-Pentane | 0.20 | 0.44 | 0.00 | 0.34 | 5.86 |
| n-Hexane | 0.33 | 0.73 | 0.00 | 0.38 | 20.01 |
| n-Heptane | 0.16 | 0.35 | 0.00 | 0.11 | 14.10 |
| CO₂ | 90.29 | 79.06 | 99.53 | 79.87 | 34.56 |
| Nitrogen | 0.89 | 1.85 | 0.10 | 1.88 | 0.13 |
| H₂O | 0.03 | 0.01 | 0.04 | 0.01 | 0.01 |
| Membrane Area [m²] | 13619 | | | | |

| | |
|---|---|
| Hydrocarbon mol % in NGL Stream | 65.31 |
| Total Hydrocarbon Molar Flow [MMSCFD] | 0.163 |

Note here, by changing the polymer material used for the membrane separation unit from a CO₂ permeance of 600 GPU and a CO₂ over CH₄ selectivity of 10 (e.g., in Example 1) to a CO₂ permeance of 40 GPU and a CO₂ over CH₄ selectivity of 33, the membrane area required is increased to 13619 m².

### Example 6

The simulation of Example 5 was repeated, again assuming that the raw gas of the compositions above was to be treated to produce a permeate gas flow of at least 17 MMSCFD with at least 97% CO₂. This time, however, the treatment process was assumed to be carried out according to the disclosed separation system shown in FIG. 2. The valve 213 divided the stream 200 into stream 201 and stream 206 at a molar flow rate ratio of 3.76.

It was assumed that the same membrane area and the same polymer material as that in the Example 5 were used for the membrane separation unit in this simulation case. The results of the simulation are shown in Table 6. The stream numbers correspond to FIG. 2. A feed gas stream 210 is-enriched in CO₂. Stream 204 and stream 208 are hydrocarbon-enriched liquid streams, which are recovered hydrocarbon liquids.

The process is able to deliver a permeate feed gas stream that is at least 17 MMSCFD with at least 97% CO₂. In this case, however, a larger permeate stream is produced (22.78 MMSCFD) compared with 17.00 MMSCFD in Example 1 (34% more). More importantly, this process produces much more net hydrocarbon liquid (0.263 MMSCFD (46.8 Mbbl/day)) compared with 0.163 MMSCFD (28.9 Mbbl/day) in Example 5, which is 61% more.

TABLE 6

| Stream | 200 | 203 | 210 | 205 | 204 | 208 |
|---|---|---|---|---|---|---|
| Temperature [° F.] | 95.0 | 72.2 | 59.2 | 72.2 | 72.2 | −1.4 |
| Pressure [psig] | 465.0 | 464.9 | 150.0 | 464.9 | 464.9 | 150.0 |
| Molar Flow [MMSCFD] | 31.00 | 8.16 | 22.78 | 7.83 | 0.33 | 0.06 |
| Component (mol %) | | | | | | |
| Methane | 3.78 | 10.68 | 1.32 | 11.03 | 2.08 | 0.32 |
| Ethane | 2.13 | 6.32 | 0.63 | 6.34 | 5.73 | 1.78 |
| Propane | 1.36 | 4.07 | 0.38 | 3.85 | 9.40 | 4.60 |
| i-Butane | 0.17 | 0.51 | 0.04 | 0.44 | 2.28 | 1.63 |
| n-Butane | 0.48 | 1.44 | 0.12 | 1.16 | 8.14 | 6.81 |
| i-Pentane | 0.27 | 0.54 | 0.03 | 0.35 | 5.24 | 6.07 |
| n-Pentane | 0.20 | 0.60 | 0.04 | 0.36 | 6.42 | 7.96 |
| n-Hexane | 0.29 | 0.99 | 0.02 | 0.31 | 17.34 | 26.30 |
| n-Heptane | 0.03 | 0.48 | 0.00 | 0.07 | 10.29 | 15.48 |
| CO₂ | 90.29 | 71.93 | 97.04 | 73.56 | 32.90 | 29.03 |
| Nitrogen | 0.89 | 2.43 | 0.34 | 2.52 | 0.18 | 0.02 |
| H₂O | 0.03 | 0.01 | 0.03 | 0.01 | 0.01 | 0.01 |
| Membrane Area [m²] | 13619 | | | | | |
| Hydrocarbon mol % in NGL Stream | | | | | 66.91 | 70.95 |
| Hydrocarbon Molar Flow [MMSCFD] | | | | | 0.22 | 0.05 |
| Total Hydrocarbon Molar Flow [MMSCFD] | | | | | | 0.263 |

### Example 7

The simulation of Example 5 was repeated, again assuming that the raw gas of the composition above was to be treated to produce a permeate gas flow of at least 17 MMSCFD with at least 97% CO₂. This time, however, the treatment process was assumed to be carried out according to the disclosed separation system shown in FIG. 2. The flow control valve 213 divided the stream 200 into stream 201 and stream 206 at a molar flow rate ratio of 5.06.

It was assumed that the same polymer material as that in the Example 5 was used for the membrane separation unit in this simulation case. The results of the simulation are shown in Table 7. The stream numbers correspond to FIG. 2. A feed gas stream 210 is-enriched in CO₂. Stream 204 and stream 208 are hydrocarbon-enriched liquid streams, which are recovered hydrocarbon liquids.

The process is able to deliver a permeate feed gas stream that is at least 17 MMSCFD with at least 97% CO₂. In this case, however, less membrane area is required (9470 m²) compared with 13619 m² for Example 5 (30% less).

TABLE 7

| Stream | 200 | 203 | 210 | 205 | 204 | 208 |
|---|---|---|---|---|---|---|
| Temperature [° F.] | 95.0 | 79.4 | 60.6 | 79.4 | 79.4 | −1.4 |
| Pressure [psig] | 465.0 | 464.7 | 150.0 | 464.7 | 464.7 | 150.0 |
| Molar Flow [MMSCFD] | 31.00 | 13.84 | 17.11 | 13.71 | 0.14 | 0.05 |
| Component (mol %) | | | | | | |
| Methane | 3.78 | 6.85 | 1.31 | 6.90 | 1.24 | 0.32 |
| Ethane | 2.13 | 3.96 | 0.65 | 3.96 | 3.41 | 1.78 |
| Propane | 1.36 | 2.54 | 0.40 | 2.51 | 5.73 | 4.60 |
| i-Butane | 0.17 | 0.32 | 0.05 | 0.31 | 1.48 | 1.63 |
| n-Butane | 0.48 | 0.90 | 0.12 | 0.85 | 5.51 | 6.81 |
| i-Pentane | 0.27 | 0.34 | 0.04 | 0.30 | 4.16 | 6.07 |
| n-Pentane | 0.20 | 0.37 | 0.04 | 0.33 | 5.33 | 7.96 |
| n-Hexane | 0.29 | 0.62 | 0.02 | 0.42 | 21.00 | 26.30 |
| n-Heptane | 0.03 | 0.30 | 0.00 | 0.13 | 17.12 | 15.48 |
| CO₂ | 90.29 | 82.22 | 97.00 | 82.68 | 34.92 | 29.03 |
| Nitrogen | 0.89 | 1.58 | 0.33 | 1.60 | 0.11 | 0.02 |
| H₂O | 0.03 | 0.02 | 0.04 | 0.02 | 0.01 | 0.01 |
| Membrane Area [m²] | 9470 | | | | | |
| Hydrocarbon mol % in NGL Stream | | | | | 64.97 | 70.95 |
| Hydrocarbon Molar Flow [MMSCFD] | | | | | 0.09 | 0.04 |
| Total Hydrocarbon Molar Flow [MMSCFD] | | | | | | 0.123 |

### Example 8

The simulation of Example 5 was repeated, again assuming that the raw gas of the composition above was to be treated to produce a permeate gas flow of at least 17 MMSCFD with at least 97% CO₂. This time, however, the treatment process was assumed to be carried out according to the disclosed separation system shown in FIG. 3. The valve 313 divided the stream 300 into stream 301 and stream 306 at a molar flow rate ratio of 5.06. A heater exchanger 316 was used to increase the production of hydrocarbon liquid.

It was assumed that the same polymer material as that in the Example 5 was used for the membrane separation unit in this simulation case. The results of the simulation are shown in Table 8. The stream numbers correspond to FIG. 3. A feed gas stream 310 is-enriched in CO₂. Stream 304 and stream 308 are hydrocarbon-enriched liquid streams, which are recovered hydrocarbon liquids.

The process is able to deliver a permeate feed gas stream that is at least 17 MMSCFD with at least 97% CO₂. In this case, however, less membrane area is required (9470 m²) compared with 13619 m² for Example 5 (30% less). More specifically, this process produces much more net hydrocarbon liquid (0.336 MMSCFD (59.7 Mbbl/day)) compared with 0.163 MMSCFD (28.9 Mbbl/day) in Example 5, which is 106% more.

TABLE 8

| Stream | 300 | 303 | 317 | 310 | 305 | 304 | 308 |
|---|---|---|---|---|---|---|---|
| Temperature [° F.] | 95 | 79.37 | 61.70 | 84.86 | 79.37 | 61.70 | −1.2 |
| Pressure [psig] | 465.0 | 464.7 | 464.2 | 150.0 | 464.7 | 464.2 | 150.5 |
| Molar Flow [MMSCFD] | 31 | 13.84 | 13.84 | 17.11 | 0.14 | 0.29 | 0.05 |
| Component (mol %) | | | | | | | |
| Methane | 3.78 | 6.85 | 6.85 | 1.31 | 6.96 | 1.36 | 0.32 |
| Ethane | 2.13 | 3.96 | 3.96 | 0.65 | 3.96 | 3.86 | 1.78 |
| Propane | 1.36 | 2.54 | 2.54 | 0.40 | 2.45 | 6.60 | 4.60 |
| i-Butane | 0.17 | 0.32 | 0.32 | 0.05 | 0.29 | 1.69 | 1.63 |
| n-Butane | 0.48 | 0.90 | 0.90 | 0.12 | 0.78 | 6.24 | 6.80 |
| i-Pentane | 0.27 | 0.34 | 0.34 | 0.04 | 0.25 | 4.40 | 6.06 |
| n-Pentane | 0.20 | 0.37 | 0.37 | 0.04 | 0.27 | 5.53 | 7.94 |
| n-Hexane | 0.29 | 0.62 | 0.62 | 0.02 | 0.26 | 17.45 | 26.32 |
| n-Heptane | 0.03 | 0.30 | 0.30 | 0.00 | 0.06 | 11.40 | 15.51 |
| CO₂ | 90.29 | 82.22 | 82.22 | 97.00 | 83.08 | 41.36 | 29.03 |
| Nitrogen | 0.89 | 1.58 | 1.58 | 0.33 | 1.61 | 0.12 | 0.02 |
| H₂O | 0.03 | 0.02 | 0.02 | 0.04 | 0.02 | 0.01 | 0.01 |
| H₂S | 0.01 | 0.00 | 0.00 | 0.00 | 0.00 | 0.00 | 0.00 |
| Membrane Area [m²] | 9470 | | | | | | |
| Hydrocarbon mol % in NGL Stream | | | | | | 99.87 | 99.97 |
| Hydrocarbon Molar Flow [MMSCFD] | | | | | | 0.29 | 0.05 |
| Total Hydrocarbon Molar Flow [MMSCFD] | | | | | | | 0.336 |

TABLE 9

| | CO₂ Permeance | | | | | | |
|---|---|---|---|---|---|---|---|
| | (GPU) and | | | | | | Target: 17 |
| | CO₂/CH₄ | | | | HC Molar | | MMSCFD |
| Ex. | selectivity | Disclosed system | Perm flow | CO₂ % | flow (MMSCFD) | M Area | and >97% purity? |
| 1 | 600/10 | M only | 17 | 98.92 | 0.26 | 757 | yes |
| 2 | 600/10 | M + J-T | 21.9 | 97.02 | 0.38 | 757 | yes |
| 3 | 600/10 | M + J-T | 17 | 97.01 | 0.20 | 580 | yes |
| 4 | 600/10 | M + J-T + HX | 17 | 97.01 | 0.31 | 580 | yes |
| 5 | 33/40 | M only | 17 | 99.53 | 0.25 | 13619 | yes |
| 6 | 33/40 | M + J-T | 22.78 | 97.04 | 0.39 | 13619 | yes |
| 7 | 33/40 | M + J-T | 17.11 | 97 | 0.19 | 9470 | yes |
| 8 | 33/40 | M + J-T + HX | 17.11 | 97 | 0.34 | 9470 | yes |

Note:
M refers to membrane. HX refers to heat exchanger.

A summary of the results of the Examples 1-8 is listed in Table 9. Based on Table 9, the disclosed separation system having a membrane separation system, a J-T expansion valve and a heat exchanger provides maximum hydrocarbon production and minimum membrane area, thereby improving cost and production efficiency.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

As used herein, “about” or “around” or “approximately” in the text or in a claim means±10% of the value stated.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

The term “enriched” as used herein is meant to refer to the concentration of a component of a product stream in relation to the concentration of that component in a feed gas stream. For example, the permeate stream from the membrane separation unit will be enriched in the readily permeable component relative to the concentration of the readily permeable component in the feed gas.

As used herein, the term “dew point” means the temperature at a given pressure wherein a condensable vapor, such as hydrocarbon or water, begins to condense.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Reference herein to “one embodiment” or “an embodiment” means that a particular feature, structure, or characteristic described in connection with the embodiment may be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

We claim:

1. A method for producing a liquid hydrocarbon product, the method comprising the steps of:
dividing a feed gas into a first feed gas stream and a second feed gas stream by a valve;
separating the first feed gas stream through a membrane separation unit into an acid gas-enriched permeate gas stream and a biphasic non-permeate stream of acid gas-reduced hydrocarbon-enriched gas and liquid;
separating the biphasic non-permeate stream of acid gas-reduced hydrocarbon-enriched gas and liquid into a first liquid hydrocarbon stream and an acid gas-depleted methane-rich gas stream by a phase separator;
expanding the second feed gas stream to produce a hydrocarbon gas stream containing acid gas in equilibrium with a second liquid hydrocarbon stream with an expander;
commingling the first liquid hydrocarbon stream with the second liquid hydrocarbon stream to produce the liquid hydrocarbons product;
commingling the acid gas-enriched permeate gas stream with the hydrocarbon gas stream containing the acid gas to produce an acid gas reinjectate; and
collecting the acid gas-depleted methane-rich gas stream for use as fuel or further processing to meet pipeline natural gas specifications.

2. The method of claim 1, further comprising the step of:
cooling the biphasic non-permeate stream of acid gas-reduced hydrocarbon-enriched gas and liquid by heat exchange with the hydrocarbon gas stream containing the acid gas in a heat exchanger, thereby increasing an output of the biphasic non-permeate stream of acid gas-reduced and hydrocarbon-enriched gas and liquid therefrom.

3. The method of claim 1, wherein the acid gas is CO₂.

4. The method of claim 1, wherein the acid gas is H₂S.

5. The method of claim 1, wherein the membrane separation unit comprises at least one membrane selective for CO₂ and/or H₂S over CH₄.

6. The method of claim 5, wherein a polymer material forming the at least one membrane has a CO₂ permeance ranging from approximately 15 to approximately 600 GPU and a selectivity of CO₂/CH₄ ranging from approximately 6 to 40.

7. The method of claim 1, wherein the expander is an isentropic expander.

8. The method of claim 7, wherein the isentropic expander is a Joule-Thomson valve.

9. The method of claim 1, wherein the feed gas includes approximately 65-95% CO₂, balanced with hydrocarbons, and other gases.

10. The method of claim 1, wherein a pressure of the acid gas-enriched permeate gas stream ranges from approximately 1 to approximately 20 bar.

11. The method of claim 1, wherein the hydrocarbon gas stream containing the acid gas comprises C₁-C₆ hydrocarbons, CO₂, and H₂S.

12. A system for producing hydrocarbons, the system comprising:
a source of a feed gas;
a valve having an inlet and first and second outlets, the valve being configured and adapted to divide the feed gas into a first feed gas stream and a second feed gas stream;
a separation stage, comprising at least one membrane and an optional first phase separator, an inlet of the separation stage being in fluid communication with a first outlet of the valve, the separation stage being configured and adapted to separate the first feed gas stream into an acid gas-enriched permeate gas stream, a first liquid hydrocarbon stream and an acid gas-depleted/methane-rich gas stream;
an expander, an inlet of the expander being in fluid communication with a second outlet of the valve, the expander being configured and adapted to cool the second feed gas stream through pressure reduction to produce an acid gas-containing hydrocarbon gas stream in equilibrium with a second liquid hydrocarbon stream,
wherein the first liquid hydrocarbon stream is commingled with the second liquid hydrocarbon stream to produce a liquid hydrocarbon product;
wherein the acid gas-enriched permeate gas stream is commingled the acid gas-containing hydrocarbon gas stream to produce an acid gas stream for reinjection into a reservoir; and
wherein the acid gas-depleted methane-rich gas stream is collected for use as fuel or further processing to meet pipeline natural gas specifications.

13. The system of claim 12, further comprising:
a second phase separator, an inlet of which being in fluid communication with an outlet of the expander, the second phase separator being configured and adapted to separate the acid gas-containing hydrocarbon gas stream and the second liquid hydrocarbon stream produced by the expander.

14. The system of claim 13, wherein:
the at least one membrane is adapted and configured to separate the first feed gas stream into the acid gas-enriched permeate gas stream and a biphasic non-permeate stream that is made up of a combination of the acid gas-containing/methane rich gas stream and the first liquid hydrocarbon stream, the biphasic non-permeate stream having gaseous and liquid phases; and
the separation stage further comprises: a heat exchanger configured and adapted to exchange heat between the acid gas-containing hydrocarbon gas stream and the biphasic non-permeate stream so as to heat the acid gas-containing hydrocarbon gas stream and cool the biphasic non-permeate stream, thereby increasing an amount of the liquid phase of the biphasic non-permeate stream, reducing an amount of the gaseous phase of the biphasic non-permeate stream, and increase a recovery of the liquid hydrocarbon product.

15. The method of claim 12, wherein the optional phase separator is present in the separation stage and comprises a drain.

16. The system of claim 12, wherein the expander is an isentropic expander.

17. The system of claim 16, wherein the isentropic expander is a Joule-Thomson valve.

18. The system of claim 12, wherein the acid gas-containing hydrocarbon gas stream comprises C₁-C₆ hydrocarbons, CO₂, and H₂S.

19. The system of claim 12, wherein the at least one membrane is selective for CO₂ and/or H₂S over CH₄.
